(19) United States
(12) Patent Application Publication
(10) Pub. No.: US 2018/0005496 A1
(43) Pub. Date: Jan. 4, 2018

(54) DISTRIBUTED HAPTICS FOR WEARABLE ELECTRONIC DEVICES

(71) Applicant: Intel Corporation, Santa Clara, CA (US)

(72) Inventors: GEORGIOS C. DOGIAMIS, Chandler, AZ (US); RAJASHREE BASKARAN, Seattle, WA (US)

(73) Assignee: Intel Corporation, Santa Clara, CA (US)

(21) Appl. No.: 15/201,205

(22) Filed: Jul. 1, 2016

(51) Int. Cl. G08B 6/00; G06F 3/01; G06F 1/16

(52) U.S. Cl. CPC G08B 6/00; G06F 1/163; G06F 3/016

(57) ABSTRACT

A wearable electronic device includes a displaceable member communicably coupled to a haptic control circuit. The haptic control circuit is communicably coupled to a configurable haptic output device. A user input, received at the displaceable member generates an input signal that includes information and/or data indicative of at least one displacement parameter associated with the displacement of the displaceable member. The input signal is communicated to the haptic control circuit. The haptic control circuit determines a haptic output parameter that corresponds to the received displacement parameter.

### TECHNICAL FIELD

The present disclosure relates to haptic output devices useful with wearable electronic devices.

### BACKGROUND

Wearable electronic devices provide enhanced user experience using haptic or tactile feedback. Current haptic feedback systems typically employ a mechanical system using a motor that causes a vibration in a member disposed within the device. The motors used to drive such motor-driven haptic feedback devices are typically quite bulky and present a significant power demand. Furthermore, such haptic feedback devices provide a “global” haptic feedback, since the feedback is not supplied to a specific location and instead causes the device itself to vibrate.

The ability to provide a structured haptic feedback in which the haptic pattern, timing, displacement and/or frequency are variable and may be adjusted to provide haptic feedback corresponding to an occurrence of a specific event rather than a “general” notification is of value since such notifications do to require the user to view the portable electronic device to determine the nature of the message or identify which specific event has occurred.

In order to be perceptible to the user, a haptic actuator must possess certain characteristics. Both the oscillatory frequency and the displacement of the haptic actuator represent factors perceptible to the device user. Human frequency perception levels at the fingertips lie between 0 Hertz (Hz) to 200 Hz. Human displacement perception levels at the fingertips lies between 10 micrometers (m) and 200 μm. Generally, the higher the oscillatory frequency, the smaller the displacement to provide a perceptible haptic output. The two point discrimination threshold, the index of the smallest perceivable spatial resolution, is about 2 millimeters (mm) at the fingertips for mechanical stimulations and about 4 mm to 6 mm at the wrist.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 depicts an illustrative wearable electronic device that includes a housing, a displaceable member 120 operably coupled to the housing, and a configurable haptic output device 130, in accordance with at least one embodiment of the present disclosure;

FIG. 2 is a block diagram of an illustrative wearable electronic device that includes a haptic control circuit, a displaceable member, and a configurable haptic output device, in accordance with at least one embodiment of the present disclosure;

FIG. 3A provides a perspective view of an embodiment of an illustrative wearable electronic device in the form of a wristwatch, in accordance with at least one embodiment of the present disclosure;

FIG. 3B provides a front view of an embodiment of an illustrative wearable electronic device in the form of a wristwatch, in accordance with at least one embodiment of the present disclosure;

FIG. 3C provides a rear view an embodiment of an illustrative wearable electronic device in the form of a wristwatch having three (3) tactors disposed on the rear case of the wristwatch, in accordance with at least one embodiment of the present disclosure;

FIG. 3D provides a rear view an embodiment of an illustrative wearable electronic device in the form of a wristwatch having four (4) tactors disposed on the rear case of the wristwatch, in accordance with at least one embodiment of the present disclosure;

FIG. 4A depicts a first illustrative haptic output pattern produced by a configurable haptic output device, in accordance with at least one embodiment of the present disclosure;

FIG. 4B depicts a second illustrative haptic output pattern produced by a configurable haptic output device, in accordance with at least one embodiment of the present disclosure;

FIG. 4C depicts a third illustrative haptic output pattern produced by a configurable haptic output device, in accordance with at least one embodiment of the present disclosure;

FIG. 5 is a high-level flow diagram of an illustrative method of a wearable electronic device providing a patterned haptic output to a user in response to receiving an input provided by the user to the wearable electronic device via a displaceable member, in accordance with at least one embodiment of the present disclosure;

FIG. 6 is a high-level flow diagram of an illustrative method of fabricating a wearable electronic device that provides a patterned haptic output in response to receiving an input via a displaceable member, in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

The systems and methods described herein provide an enhanced user experience by providing a selectively configurable haptic output on the external surface of a wearable electronic device that contacts a user's skin surface. One or more displaceable members operably coupled to the wearable electronic device may be displaced or moved, and various displacement parameters of the displaceable member (direction, speed, etc.) may be used to alter, control, or adjust one or more haptic output parameters (pattern, displacement, frequency, etc.). In one embodiment, the wearable electronic device may include a wristwatch having a rotatable bezel on the watch face and a configurable haptic output on the back of the watch case (proximate the wrist of the user). User inputs received via the bezel may alter, control, or adjust the haptic output applied to the user's wrist.

In devices worn proximate a user's skin, the user's skin may provide the capability for supplying haptic feedback using a dynamic, configurable, and/or complex haptic output. Such broad configurability provides designers with a multitude of options to de-clutter the user interface on wearable electronic devices. The use of haptic feedback on small form factor and wearable electronic devices provides the user with a lifestyle that is not dominated by a display, but instead by an intuitive, timely, and discrete interface using tactile or haptic feedback. Moreover, the use of a displaceable member as an input device may beneficially permit the use of the wearable electronic device as the user provides input. For example, rather than obscuring a portion of the device display with an input “button” or “keyboard,” the use of a displaceable member may permit the user to interact with the display while providing input to the device (e.g., send data to the device, receive notifications from the device). In one example, a user may rotate a watch bezel to scroll through a list containing a plurality of options and may “press” or “click” the bezel to select one of the plurality of options. Such an arrangement beneficially permits the user to continue to use the watch face while examining the list of options and selecting one of the options.

The systems and methods described herein allow for the creation of localized haptic feedback that enhances the user experience, particularly with small form factor wearable electronic devices. The systems and methods described herein provide such enhanced user experience by mapping the movements of a moveable member coupled to the wearable electronic device to the haptic output patterns generated by the device. In one embodiment, such may be accomplished using a number of small haptic actuators disposed in a pattern on the back of a watch case. The rotation of the watch bezel in a clockwise or counterclockwise direction may be mapped to the haptic output patterns applied to the user's wrist. Such output may also be used to provide the user with notifications according to preset settings, navigational assistance, and similar.

A system for providing haptic output on a wearable electronic device is provided. The system may include a means for operably coupling a displaceable member to an external surface of a wearable electronic device; a means for disposing a haptic array on at least a portion of the exterior surface of the wearable electronic device; a means for communicably coupling the displaceable member to a haptic control circuit; a means for communicably coupling the haptic array to the haptic control circuit; and a means for communicably coupling a storage device that includes a library of haptic array outputs, each logically associated with a respective one of a plurality of inputs received via the displaceable member.

A method of providing haptic output on a wearable electronic device is provided. The method may include operably coupling a displaceable member to an external surface of a wearable electronic device; disposing a haptic array on at least a portion of the exterior surface of the wearable electronic device; communicably coupling the displaceable member to a haptic control circuit; communicably coupling the haptic array to the haptic control circuit; and communicably coupling a storage device that includes a library of haptic array outputs, each logically associated with a respective one of a plurality of inputs received via the displaceable member.

A system for providing haptic output on a wearable electronic device is provided. The system may include a means for receiving a signal that includes data indicative of at least one displacement parameter corresponding to a user input received via a displaceable member operably coupled to the wearable electronic device; a means for determining a haptic output parameter corresponding to the received signal that includes data indicative of at least one displacement parameter; a means for generating an output signal that includes data indicative of at least one haptic output parameter; and a means for causing a displacement of a haptic output device disposed at least partially on an exterior surface of the wearable electronic device.

A method of providing haptic output on a wearable electronic device is provided. The method may include receiving, at an input interface circuit, a signal that includes data indicative of at least one displacement parameter corresponding to a user input received via a displaceable member operably coupled to the wearable electronic device; determining, by a haptic control circuit, a haptic output parameter corresponding to the received signal that includes data indicative of at least one displacement parameter; generating, by the haptic control circuit, an output signal that includes data indicative of at least one haptic output parameter; and causing a displacement of a haptic output device disposed at least partially on an exterior surface of the wearable electronic device.

A wearable electronic device haptic feedback controller is provided. The controller may include an input interface circuit to receive a signal that includes data indicative of at least one displacement parameter corresponding to a user input received via the displaceable member; an output interface circuit to provide an output signal that includes data indicative of at least one haptic output parameter; a configurable circuit communicably coupled to the input interface circuit and to the output interface circuit; and a storage device communicably coupled to the configurable circuit, the storage device including machine-readable instructions that, when executed by the configurable circuit transform at least a portion of the configurable circuit to a haptic control circuit, the haptic control circuit to: receive, via the input interface circuit, the signal that includes data indicative of at least one displacement parameter corresponding to a user input received via the displaceable member; and provide, via the output interface circuit, the output signal that includes data indicative of at least one haptic output parameter, wherein the at least one haptic output parameter corresponds to the received at least one displacement parameter.

A haptic feedback system for wearable electronic devices is provided. The system may include a housing; a haptic output sub-system forming at least a portion of an exterior surface of the housing, the haptic output sub-system providing a selectively configurable haptic output pattern; a displaceable member operably coupled to the housing; a configurable circuit operably coupled to the displaceable member and to the haptic output sub-system; and a storage device communicably coupled to the configurable circuit, the storage device including machine-readable instructions that, when executed by the configurable circuit transform at least a portion of the configurable circuit to a haptic control circuit, the haptic control circuit to: receive a signal that includes data indicative of at least one displacement parameter corresponding to a user input received via the displaceable member; and generate an output signal that includes data indicative of at least one haptic output parameter corresponding to the received at least one displacement parameter.

As used herein, the term “wearable electronic device” refers to any electronic device capable of being attached, affixed, or placed proximate at least a portion of the device user's body. Example wearable electronic devices may include, but are not limited to, eyewear (e.g., Google Glass®, Google, Inc. Mountain View, Calif.); pendants, bracelets, braces, broaches, rings, watches, and similar wearable devices or fashion appurtenances.

As used herein, the terms “top,” “bottom,” “up,” “down,” “upward,” “downward,” “upwardly,” “downwardly” and similar directional terms should be understood in their relative and not absolute sense. Thus, a component described as being “upwardly displaced” may be considered “laterally displaced” if the device carrying the component is rotated 90 degrees and may be considered “downwardly displaced” if the device carrying the component is inverted. Such implementations should be considered as included within the scope of the present disclosure.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

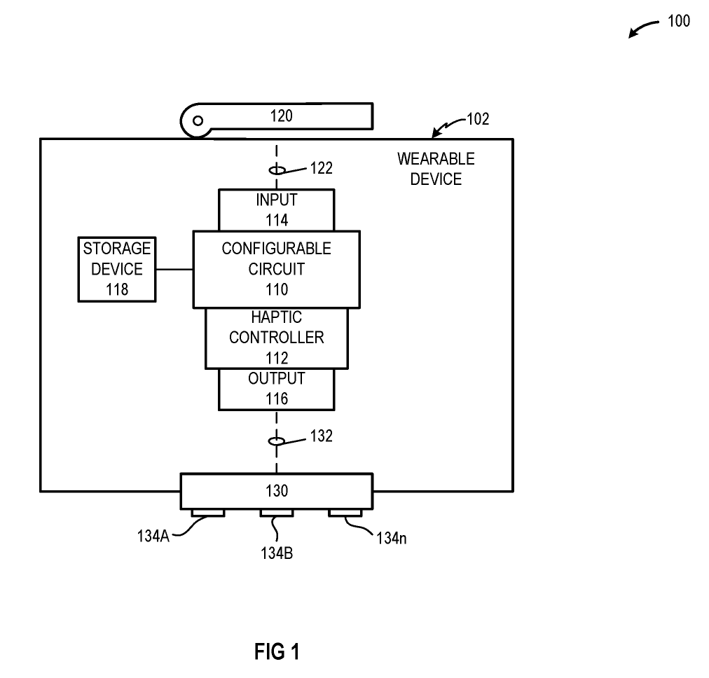

FIG. 1 depicts an illustrative wearable electronic device 100 that includes a housing 102, a displaceable member 120 operably coupled to the housing 102, and a configurable haptic output device 130, in accordance with at least one embodiment of the present disclosure. As depicted in FIG. 1, by executing one or more sets of machine-readable instructions, all or a portion of a configurable circuit 110 may be transformed into a dedicated haptic control circuit 112. The haptic control circuit 112 may receive input from the displaceable member 120 via input interface circuitry 114. The haptic control circuit 112 may output one or more signals to the configurable haptic output device 130 via output interface circuitry 116. In embodiments, user interaction with the displaceable member 120 causes the generation of an input signal 122 that includes information and/or data representative of one or more displacement parameters. Such displacement parameters may include, but are not limited to, a displacement direction (clockwise rotation, counterclockwise rotation, planar displacement along x- and y-axes, perpendicular displacement along a z-axis, etc.), a displacement speed or velocity, a displacement frequency, or combinations thereof.

The haptic control circuit 112 receives the input signal 122 at an input interface circuit 114. Responsive to the receipt of the input signal 122, the haptic control circuit 112 generates an output signal 132 at the output interface circuit 116. The output signal 132 includes information and/or data indicative of one or more haptic output parameters. The one or more haptic output parameters may include, but are not limited to, a haptic output pattern, a haptic output direction, a haptic output displacement, a haptic output rhythm, and/or a haptic output frequency.

The housing 102 may have any size, shape, configuration, and/or geometry capable of being worn or otherwise disposed proximate the body of the device user. In some implementations, the housing may be in the form of a watch, pendant, necklace, eyewear, broach, or other decorative or functional jewelry or similar. The housing 102 may be metallic, non-metallic or any combination thereof. The housing may be affixed or attached to the device user via one or more straps, belts, fasteners, hooks, or similar.

The configurable circuit 110 may include any number and/or combination of devices and/or systems capable of executing machine-readable instructions. The configurable circuit 110 may include any number and/or combination of electrical components and/or semiconductor devices. In embodiments, the configurable circuit may be partially or wholly composed of hardwired components. In embodiments, the configurable circuit may include one or more processors situated in separate components, or alternatively, may comprise one or more processing cores embodied in a single component (e.g., in a System-on-a-Chip (SOC) configuration). Example processors may include various x86-based microprocessors available from the Intel Corporation (Santa Clara, Calif.) and include those in the Pentium®, Xeon®, Itanium®, Celeron®, Atom®, Core i-series product families. The configurable circuit 110 may include devices and systems such as, digital signal processors (DSPs), reduced instruction set computers (RISCs), application specific integrated circuits (ASICs), programmable gate arrays (PGAs), or similar.

The configurable circuit 110 executes machine-readable instructions that may include program code, instructions, or similar logic configured to transform at least a portion of the configurable circuit 110 to a dedicated and particular haptic control circuit 112. Either or both the configurable circuit 110 and/or the haptic control circuit 112 may variously perform activities related to reading data, writing data, processing data, formulating data, converting data, transforming data, etc. The configurable circuit 110 and/or the haptic control circuit 112 may be communicably coupled to an input interface circuit 114 and/or an output interface circuit 116.

Information and/or data (e.g., instructions, data structures, program data, and similar) may be stored or otherwise retained in storage device 118. The storage device 118 may include any number and/or combination of storage devices and/or storage systems capable of retaining, holding, or otherwise storing digital data. In embodiments, the storage device 118 may include one or more non-transitory storage media, such as one or more magnetic storage media, one or more optical storage media, one or more atomic or molecular storage media, one or more electrically erasable programmable read only memory (EEPROM) storage media, or combinations thereof.

The displaceable member 120 may include any number and/or combination of devices and/or systems capable of generating the input signal 122 in response to a user displacing, moving or otherwise transitioning the displaceable member 120 from at least a first position or location to at least a second position or location. The displaceable member 120 may be pivotably, slideably, rotatably, translationally, or otherwise moveably coupled to the wearable electronic device housing 102. In some implementations, all or a portion of the displaceable member 120 may form all or a portion of a decorative portion of the wearable electronic device housing 102. In some implementations, all or a portion of the displaceable member 120 may form all or a portion of a functional portion of the wearable electronic device housing 102. For example, the displaceable member 120 may form all or a portion of a functional or decorative bezel surrounding a crystal on a wristwatch.

The displaceable member 120 may be displaceable in a plurality of directions, for example rotatably displaceable, planarly displaceable (e.g., along or in an X-Y plane disposed parallel to the housing 102), perpendicularly displaceable (e.g., along a Z-axis disposed perpendicular to the housing 102), or any combination thereof. For example, a displaceable member in the form of a watch bezel may be rotatably displaceable about the watch crystal and may be perpendicularly displaceable along an axis perpendicular to the watch crystal. Such a configuration may advantageously permit the rotation of the watch bezel/displaceable member 120 by the user to scroll through a number of options and the displacement of the watch bezel/displaceable member 120 along the perpendicular axis to select an option from the number of options.

The configurable haptic output device 130 may include any number and/or combination of haptic output devices and/or haptic output systems capable of providing a haptic output perceptible to a user when the wearable electronic device 100 is placed proximate the user. In embodiments, the configurable haptic output device 130 may include a plurality of individual haptic output devices or “tactors” 134A-134n (collectively, “tactors 134”) arranged in a pattern on at least a portion of an exterior surface of the wearable electronic device 100. For example, the configurable haptic output device 130 may include three (3) or four (4) individual tactors 134 arranged in a pattern on the lower surface of the back of a watch case.

The tactors 134 forming the configurable haptic output device 130 may be individually controlled by the haptic control circuit 112. For example, the haptic control circuit 112 may selectively control the timing (i.e., the sequencing) of the individual tactors 134 included in the configurable haptic output device 130 such that some or all of the tactors 134 operate in a sequential manner or such that the tactors 134 operate sequentially with a delay period interposed between at least some of the tactors 134. In another example, at least a portion of the tactors 134 may operate in parallel (i.e., contemporaneously or simultaneously) while other tactors operate sequentially. In addition, or alternatively, the haptic control circuit 112 may selectively control the displacement, output frequency, and/or output rhythm of each individual tactor 134 included in the configurable haptic output device 130. Advantageously, since the output parameters of each tactor 134 included in the configurable haptic output device 130 may be individually controlled and/or adjusted by the haptic control circuit 112, a large number of potential tactor output configurations/patterns may be generated by the haptic control circuit 112.

The tactors 134 may include any number and/or combination of devices and/or systems capable of providing a physical displacement at a defined intensity and frequency such that a user is aware of the physical displacement of the tactor 134. The tactors may include any current or future developed haptic feedback device and/or system. Example tactors 134 include, but are not limited to, linear resonant actuators (LRAs), eccentric rotating mass (ERMs) motors, piezoelectric actuators, microfluidic actuators, electroactive polymer actuators or combinations thereof. In some implementations, the tactors 134 may be covered by an elastomeric coating to provide a water-proof, perspiration-proof system when disposed on an exterior surface of a wearable electronic device 100. In some implementations, the tactor 134 may have a displacement of about 25 micrometers (μm) or less; about 50 μm or less; about 75 μm or less; about 100 μm or less; about 150 μm or less; or about 200 μm or less. In some implementations, the tactor 134 may have an oscillatory frequency of about 10 Hz or less; about 25 Hz or less; about 50 Hz or less; about 75 Hz or less; about 100 Hz or less; about 150 Hz or less; or about 200 Hz or less. In some implementations, the spacing between adjacent tactors 134 may be about 1 mm or less; about 2 mm or less; about 4 mm or less; about 5 mm or less; about 6 mm or less; or about 10 mm or less.

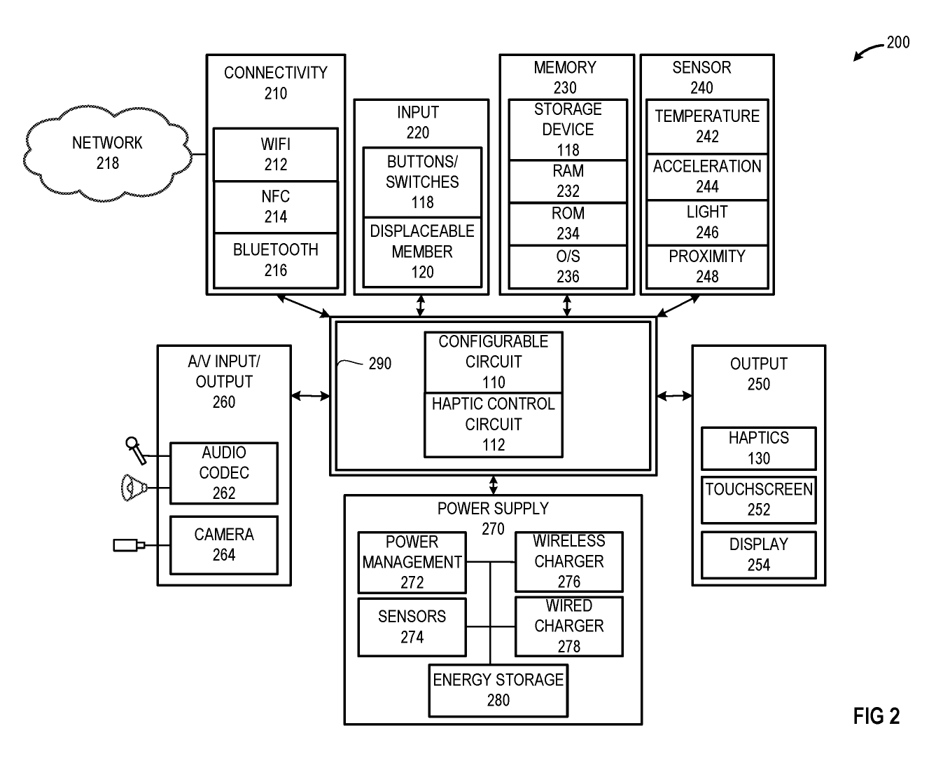

FIG. 2 is a block diagram of an illustrative wearable electronic device 200 that includes a haptic control circuit 112, a displaceable member 120, and a configurable haptic output device 130, in accordance with at least one embodiment of the present disclosure. The wearable electronic device 200 may include one or more of the following: a connectivity subsystem 210; an input subsystem 220; a memory subsystem 230; a sensor subsystem 240; an output subsystem 250; an audio/visual (A/V) input/output system 260; and a power supply subsystem 270. The various subsystems may be communicably coupled to the configurable circuit 110 and/or the haptic control circuit 112 via one or more communications links 290. For example, via one or more serial or parallel buses 290.

The connectivity subsystem 210 may include any number and/or combination of wired and/or wireless transmitters, receivers, and/or transceivers. Example transceivers include, but are not limited to, one or more IEEE 802.11 (Wi-Fi®) transceivers 212; one or more Near Field Communication (NFC) transceivers 214; one or more BLUETOOTH® transceivers 216; or any combination thereof. In at least some implementations, the connectivity subsystem 210 enables the wearable electronic device 200 to communicably couple to one or more external devices via one or more networks 218. The one or more networks 218 may include, but are not limited to, one or more local area networks (LANs); one or more metropolitan area networks (MANs); one or more virtual private networks (VPNs); one or more wide area networks (WANs); and/or one or more worldwide are networks (WWANs, such as the Internet).

The input subsystem 220 may include any number and/or combination of devices and/or systems capable of receiving user input and providing one or more signals including information and/or data corresponding to the received user input to the configurable circuit 110 and/or the haptic control circuit 112. The input subsystem 220 may include input devices such as one or more buttons or switches 222; one or more keyboards or similar text entry devices 224; and/or one or more pointing devices 226. The displaceable member 120 may be included in the input subsystem 220.

The memory subsystem 230 may include any number and/or combination of any current and/or future developed devices and/or systems capable of storing or otherwise retaining digital information and/or data. The memory subsystem 230 may include random access memory (RAM) 232 and/or read-only memory (ROM) 234 in a fixed or removable format. In some implementations, the memory subsystem 230 may store or otherwise retain machine-readable instruction sets such as bootstrap code to enable the loading of an operating system 236 upon startup of the wearable electronic device 200. The memory subsystem 230 may include memory configured to hold information and/or data generated during the operation of wearable electronic device 200. Such memory may include, but is not limited to, static RAM (SRAM) or Dynamic RAM (DRAM). The ROM 234 may include storage devices such as basic input/output system (BIOS) memory configured to provide instructions when the wearable electronic device 200 activates, programmable memories such as electronic programmable ROMs, (EPROMS), Flash, etc. The memory subsystem 230 may include other fixed and/or removable memory such as floppy disks, hard drives, etc., electronic memories such as solid state flash memory (e.g., eMMC), removable memory cards or sticks (e.g., uSD, USB), optical memories such as compact disc-based ROM (CD-ROM), or combinations thereof. The memory subsystem 230 may further include the one or more storage devices 118.

The memory subsystem 230 may include data, machine-readable instruction sets, and/or applications 238 that may cause the haptic control circuit to generate an output signal that includes information and/or data representative of one or more haptic output parameters based at least in part on the receipt of a signal containing information and/or data indicative of one or more displacement parameters associated with the displacement of the displaceable member 120 from a first location or position to a second location or position. The memory subsystem 230 may include one or more applications 238 that cause the haptic control circuit to perform one or more lookup operations in a data structure stored or otherwise retained in the storage device 118 to determine a haptic output parameter corresponding to a particular displacement parameter. The memory subsystem 230 may include one or more applications 238 that permit the user to define a particular haptic output parameter as corresponding to a defined displacement parameter.

The sensor subsystem 240 may include any number and/or combination of current and/or future developed devices and/or systems capable of detecting one or more internal and/or external parameters and/or conditions and generating one or more signals containing information and/or data representative of the respective detected parameter and/or condition. The sensor subsystem 240 may include, but is not limited to, one or more temperature sensors 242; one or more acceleration sensors 244; one or more light sensors 246; one or more proximity sensors 248; or any combination thereof. In embodiments, the sensor subsystem 240 may provide the configurable circuit 110 and/or the haptic control circuit 112 with information and/or data indicative of one or more operational parameters of the wearable electronic device 200; one or more motion, direction, or orientations parameters of the wearable electronic device 200; one or more external conditions about the wearable electronic device 200; or any combination thereof.

In some implementations, the sensor subsystem 240 may include one or more conductivity sensors to determine whether the wearable electronic device 200 is disposed proximate a skin surface of the user. Responsive to receipt of information and/or data indicative that the wearable electronic device 200 is disposed proximate a user's skin, the haptic control circuit 112 may determine a tactor displacement appropriate for use when the wearable electronic device 200 is proximate a skin surface. Responsive to receipt of information and/or data indicative the wearable electronic device is not disposed proximate a user's skin, the haptic control circuit 112 may select a tactor displacement appropriate for use when the wearable electronic device 200 is not proximate s skin surface.

The output subsystem 250 may include any number and/or combination of current and/or future developed devices and/or systems capable of generating one or more user perceptible outputs. The output subsystem 250 may include one or more touchscreen output devices 252 and/or one or more display devices 254, or combinations thereof. The output subsystem 250 includes the configurable haptic output device 130. In embodiments, the configurable circuit 110 and/or the haptic control circuit 112 may generate one or more output signals that include information and/or data indicative of one or more haptic parameters. The one or more haptic parameters may include, but are not limited to, a haptic output pattern; a haptic output intensity; a haptic output frequency; a haptic output rhythm; and/or a haptic output displacement.

The A/V Input/Output (I/O) subsystem 260 may include any number and/or combination of current and/or future developed devices and/or systems capable of receiving and/or transmitting audio data and/or video data. The A/V I/O system 260 may include, but is not limited to, one or more audio coders; one or more audio decoders; one or more audio codecs 262; one or more video capture devices 264; or combinations thereof. In some implementations, the one or more video capture devices may include one or more visible spectrum video capture devices and/or one or more infrared video capture devices.

The power supply subsystem 270 may include any number and/or combination of any current and/or future developed devices and/or systems capable of providing the wearable electronic device 200 with operating power. The power supply subsystem 270 may include, but is not limited to, one or more power management control circuits 272; one or more power sensors 274 (voltage sensors, current sensors, etc.); one or more wireless charging systems 276; one or more wired charging systems 278; one or more energy storage devices 280 (secondary batteries, supercapacitors, ultracapacitors, etc.) or combinations thereof.

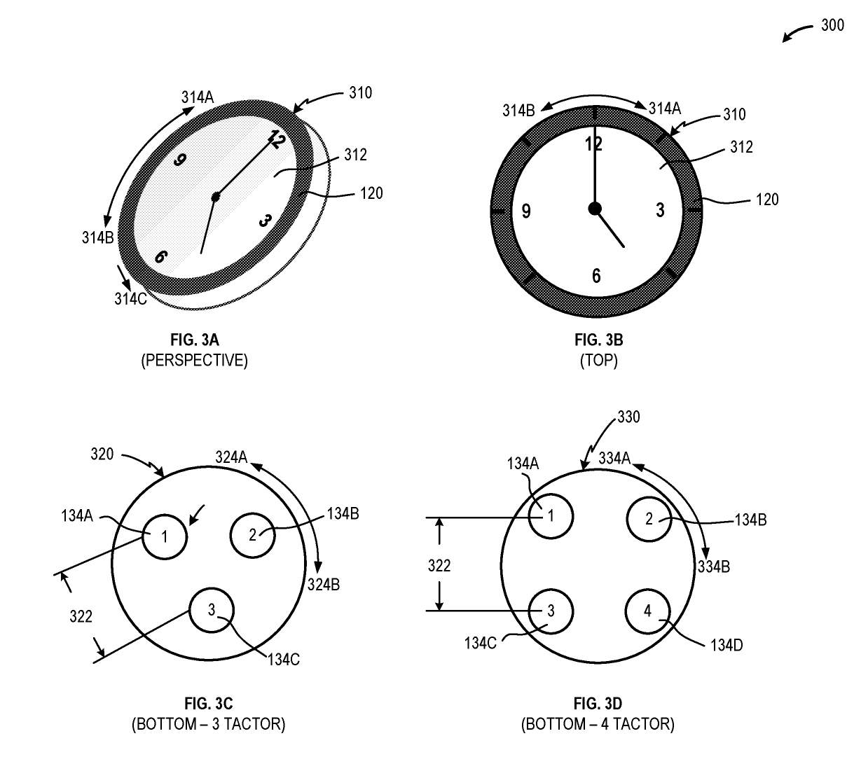

FIG. 3A provides a perspective view of an embodiment of an illustrative wearable electronic device 300 in the form of a wristwatch, in accordance with at least one embodiment of the present disclosure. FIG. 3B provides a front view of an embodiment of an illustrative wearable electronic device 300 in the form of a wristwatch, in accordance with at least one embodiment of the present disclosure. FIG. 3C provides a rear view of an embodiment of an illustrative wearable electronic device 300 in the form of a wristwatch having three (3) tactors 134 disposed on the rear of the watch case, in accordance with at least one embodiment of the present disclosure. FIG. 3A provides a rear view of an embodiment of an illustrative wearable electronic device 300 in the form of a wristwatch having four (4) tactors 134 disposed on the rear of the watch case, in accordance with at least one embodiment of the present disclosure.

As depicted in FIGS. 3A, 3B, 3C, and 3D, the wearable electronic device 300 includes a watch face 312 that is at least partially surrounded by a bezel which functions as the displaceable member 120. The displaceable member 120 is rotatably coupled to the wearable electronic device 300 and may be displaced (i.e., via rotation) in a clockwise direction 314A and in a counterclockwise direction 314B. In the illustrated embodiment, the direction of rotation may alter or adjust one haptic output parameter, such as the direction of rotation of the tactors 134 forming the configurable haptic output device 130 on the back of the watch case. In the illustrated embodiment, the speed with which the bezel is rotated may alter or adjust one haptic output parameter, such as the intensity of the tactors 134 or the oscillatory frequency of the tactors 134.

In some implementations, the displaceable member 120 may be displaceable in one or more different directions, such as vertically downward 314C. Such may be accomplished, for example, by pressing or “clicking” the displaceable member. Other displacements are possible. For example, the displaceable member 120 may be pinned at one or more pivot points that facilitate the “rocking” or “pivoting” of the displaceable member about the pivot point. In the wristwatch example depicted in FIGS. 3A, 3B, 3C, and 3D, such may be accomplished, for example, by pinning the watch bezel at the 3 o'clock and 9 o'clock positions such that the bezel pivots about an axis through the 3 o'clock and 9 o'clock positions. Alternatively, again using the example wristwatch depicted in FIG. 3, the bezel/displaceable member 120 may be pinned at the 12 o'clock and at the 6 o'clock positions such that the bezel pivots about an axis through the 12 o'clock and 6 o'clock positions

In one embodiment exemplified by watch case 320, the configurable haptic output device 130 may be disposed on the rear surface of the watch case 320. In such embodiments, the configurable haptic output device 130 may include three (3) tactors 134A, 134B, and 134C disposed in a regularly spaced, triangular, pattern. The spacing 322 between the tactors 134 may be about 1.5 millimeters (mm) or more; about 2.0 mm or more; about 2.5 mm or more; about 3.0 mm or more; about 4.0 mm or more; or about 5.0 mm or more. In some implementations, the direction of rotation of the displaceable member 120 may determine the direction of rotation of the tactors 134 included in the configurable haptic output device 130. For example, if the displaceable member 120 is rotated clockwise 314A, then the haptic output pattern may sequence in a corresponding clockwise pattern 324A. Conversely if the displaceable member 120 is rotated counterclockwise 314B, then the haptic output pattern may sequence in a corresponding counterclockwise pattern 324B.

In another embodiment exemplified by watch case 330, the configurable haptic output device 130 may be disposed on the rear surface of the watch case 320. In such embodiments, the configurable haptic output device 130 may include four (4) tactors 134A, 134B, 134C, and 134D disposed in a regularly spaced, square, pattern. The spacing 322 between the tactors 134 may be about 1.5 millimeters (mm) or more; about 2.0 mm or more; about 2.5 mm or more; about 3.0 mm or more; about 4.0 mm or more; or about 5.0 mm or more. In some implementations, the direction of rotation of the displaceable member 120 may determine the direction of rotation of the tactors 134 included in the configurable haptic output device 130. For example, if the displaceable member 120 is rotated clockwise 314A, then the haptic output pattern may sequence in a corresponding clockwise pattern 334A. Conversely if the displaceable member 120 is rotated counterclockwise 314B, then the haptic output pattern may sequence in a corresponding counterclockwise pattern 334B.

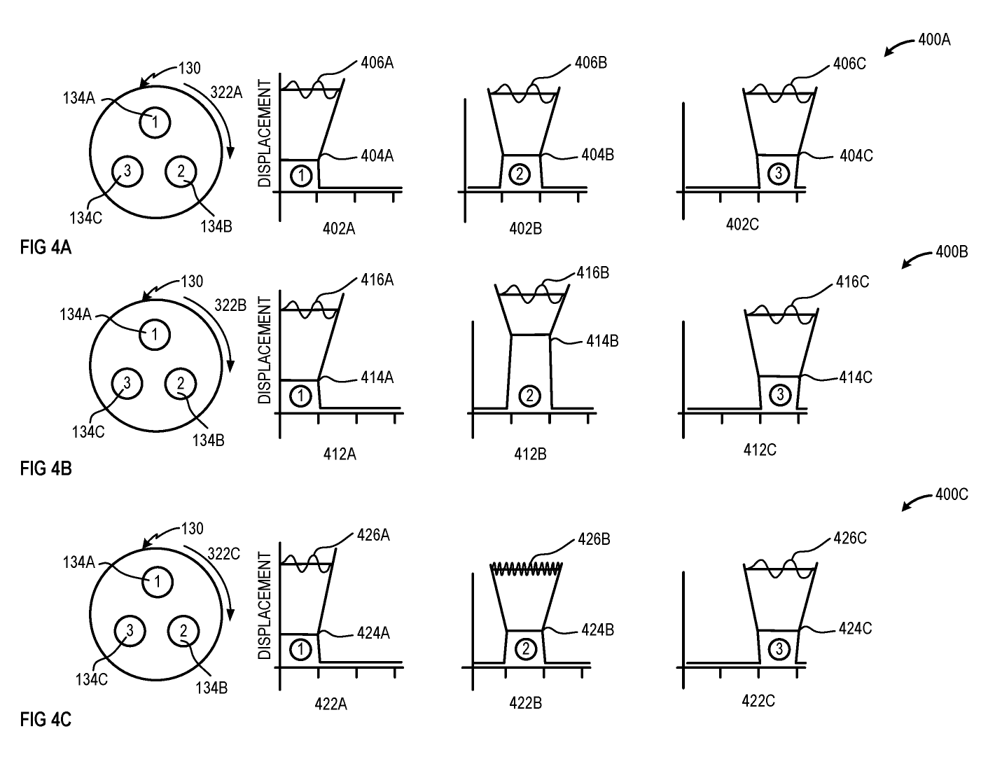

FIG. 4A depicts a first illustrative haptic output pattern 400A produced by a configurable haptic output device 130, in accordance with at least one embodiment of the present disclosure. As depicted in FIG. 4A, tactors 134A-134C operate sequentially clockwise. As depicted in operating plot 402A, tactor 134A is displaced a distance 404A and operates at an oscillatory frequency 406A. As depicted in operating plot 402B, tactor 134B is displaced an equal distance 404B and operates at the same oscillatory frequency 406B. As depicted in operating plot 402C, tactor 134C is also displaced an equal distance 404C and operates at the same oscillatory frequency 406C.

FIG. 4B depicts a second illustrative haptic output pattern 400B produced by a configurable haptic output device 130, in accordance with at least one embodiment of the present disclosure. As depicted in FIG. 4B, tactors 134A-134C operate sequentially clockwise. As depicted in operating plot 412A, tactor 134A is displaced a first distance 414A and operates at a first oscillatory frequency 416A. As depicted in operating plot 412B, tactor 134B is displaced a second distance 414B that is different from the first distance 414A and operates at the first oscillatory frequency 416B. As depicted in operating plot 412C, tactor 134C is displaced the first distance 414C and operates at the first oscillatory frequency 416C.

FIG. 4C depicts a third illustrative haptic output pattern 400C produced by a configurable haptic output device 130, in accordance with at least one embodiment of the present disclosure. As depicted in FIG. 4C, tactors 134A-134C operate sequentially clockwise. As depicted in operating plot 422A, tactor 134A is displaced a first distance 424A and operates at a first oscillatory frequency 426A. As depicted in operating plot 422B, tactor 134B is displaced the first distance 424B and operates at a second oscillatory frequency 426B that is different than the first oscillatory frequency 424A. As depicted in operating plot 422C, tactor 134C is displaced the first distance 424C and operates at the first oscillatory frequency 426C.

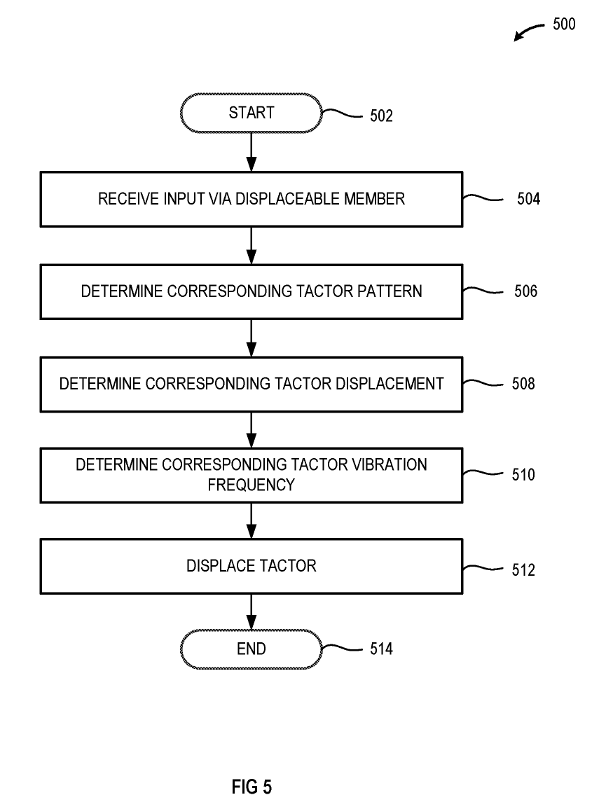

FIG. 5 is a high-level flow diagram of an illustrative method 500 of a wearable electronic device providing a patterned haptic output to a user in response to receiving an input provided by the user to the wearable electronic device 100 via a displaceable member 120, in accordance with at least one embodiment of the present disclosure. The method 500 commences at 502.

At 504, the device user provides an input to the haptic control circuit 112 by moving or otherwise displacing a displaceable member 120 operably coupled to the wearable electronic device 100. In some implementations, the user may displace the displaceable member from a first location or position to a second location or position. In some implementations, the displaceable member 120 may generate one or more signals that include information and/or data representative or indicative of the displacement parameters (e.g., direction, speed) of the displaceable member 120 by the device user. The signal provided by the displaceable member 120 may be received by an input interface circuit 114 communicably coupled to the configurable circuit 110 and/or the haptic control circuit 112.

At 506, the haptic control circuit 112 determines one or more haptic output patterns logically associated with the displacement parameters. In some implementations, the haptic control circuit 112 may determine the one or more haptic output patterns using one or more data structures (e.g., databases, data stores, or similar) stored or otherwise retained in, on, or about the storage device 118.

At 508, the haptic control circuit 112 determines one or more haptic output displacements logically associated with the displacement parameters. In some implementations, the haptic control circuit 112 may determine the one or more haptic output displacements using one or more data structures (e.g., databases, data stores, or similar) stored or otherwise retained in, on, or about the storage device 118.

At 510, the haptic control circuit 112 determines one or more haptic output oscillatory frequencies logically associated with the displacement parameters. In some implementations, the haptic control circuit 112 may determine the one or more haptic output oscillatory frequencies using one or more data structures (e.g., databases, data stores, or similar) stored or otherwise retained in, on, or about the storage device 118.

At 512, the haptic control circuit 112 generates an output signal 132 that includes information and/or data indicative of the haptic output parameters logically associated with the received displacement parameters as determined at 506, 508, and 510. The haptic control circuit 112 communicates the output signal 132 to the configurable haptic output device 130. Responsive to receipt of the output signal 132 at the configurable haptic output device 130, the tactors 134 included in the configurable haptic output device 130 provide the haptic feedback provided by the haptic feedback parameters in the output signal 132. The method 500 concludes at 514.

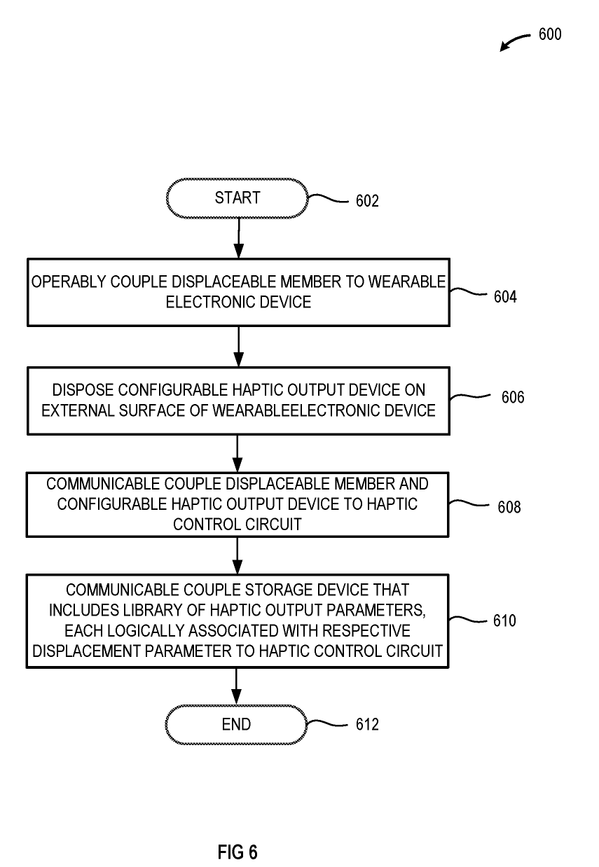

FIG. 6 is a high-level flow diagram of an illustrative method 600 of fabricating a wearable electronic device that provides a patterned haptic output in response to receiving an input via a displaceable member 120, in accordance with at least one embodiment of the present disclosure. The method 600 commences at 602.

At 604, at least one displaceable member 120 may be operably attached to the wearable electronic device 100. In embodiments, the displaceable member 120 may be operably coupled to a portion of an exterior surface of the wearable electronic device 100. Such displaceable members 120 may include any member, device, and/or system capable of being physically manipulated by the device user in a manner that provides an input signal to the haptic control circuit 112. In some implementations, the displaceable member 120 may include one or more members such as a watch bezel, watch crown, pushbutton or similar device or appurtenance.

At 606, a configurable haptic output device 130 is disposed in, on, or about at least a portion of an exterior surface of the wearable electronic device 100. The configurable haptic output device 130 may include any number of individual tactors 134 arranged in a regular or irregular pattern on the exterior surface of the wearable electronic device 100.

At 608, the displaceable member 120 and the configurable haptic output device 130 are communicably coupled to the haptic control circuit 112. In some implementations, the displaceable member 120 may be communicably coupled to an input interface circuit 114. In some implementations, the configurable haptic output device 130 may be communicably coupled to an output interface circuit 116.

At 610, a storage device 118 is communicably coupled to the haptic control circuit 112. The storage device 118 includes one or more data structures that provide information and/or data that logically associates one or more displacement parameters received from the displaceable member 120 with one or more haptic output parameters for transmission to the configurable haptic output device 130. The method 600 concludes at 612.

Additionally, operations for the embodiments have been further described with reference to the above figures and accompanying examples. Some of the figures may include a logic flow. Although such figures presented herein may include a particular logic flow, it can be appreciated that the logic flow merely provides an example of how the general functionality described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited to this context.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. Thus, the breadth and scope of the present invention should not be limited by any of the above-described exemplary embodiments, but should be defined only in accordance with the following claims and their equivalents.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

As described herein, various embodiments may be implemented using hardware elements, software elements, or any combination thereof. Examples of hardware elements may include processors, microprocessors, circuits, circuit elements (e.g., transistors, resistors, capacitors, inductors, coils, transmission lines, slow-wave transmission lines, transformers, and so forth), integrated circuits, application specific integrated circuits (ASIC), wireless receivers, transmitters, transceivers, smart antenna arrays for beamforming and electronic beam steering used for wireless broadband communication or radar sensors for autonomous driving or as gesture sensors replacing a keyboard device for tactile internet experience, screening sensors for security applications, medical sensors (cancer screening), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The following examples pertain to further embodiments. The following examples of the present disclosure may comprise subject material such devices, systems, methods, and means for providing a wearable electronic device 100 that includes a configurable haptic output device 130. A haptic control circuit 112 generates an output signal 132 that alters, controls, or adjusts one or more haptic output parameters (e.g., haptic pattern, haptic displacement or intensity, and/or haptic oscillatory frequency or rhythm) based on an input signal 122 that includes one or more displacement parameters. The one or more displacement parameters are generated when a user displaces or otherwise moves a displaceable member 120 that is operably coupled to the wearable electronic device 100.

According to example 1, there is provided a haptic feedback system for wearable electronic devices. The system may include a housing; a haptic output sub-system forming at least a portion of an exterior surface of the housing, the haptic output sub-system providing a selectively configurable haptic output pattern; a displaceable member operably coupled to the housing; a configurable circuit operably coupled to the displaceable member and to the haptic output sub-system; and a storage device communicably coupled to the configurable circuit, the storage device including machine-readable instructions that, when executed by the configurable circuit transform at least a portion of the configurable circuit to a haptic control circuit, the haptic control circuit to: receive a signal that includes data indicative of at least one displacement parameter corresponding to a user input received via the displaceable member; and generate an output signal that includes data indicative of at least one haptic output parameter corresponding to the received at least one displacement parameter.

Example 2 may include elements of example 1 where the data indicative of the at least one displacement parameter may include data indicative of at least one of: a displacement direction of the displaceable member; a displacement speed of the displaceable member; and a rate of change of the displacement speed of the displaceable member.

Example 3 may include elements of example 2 where the data indicative of the at least one haptic output parameter may include data indicative of at least one of: a haptic output pattern; a haptic output rhythm; and a haptic output intensity.

Example 4 may include elements of example 3 where the haptic output subsystem may include a plurality of linear resonant actuators, a plurality of eccentric rotating mass motors, a plurality of piezoelectric actuators, or a plurality of microfluidic actuators.

Example 5 may include elements of example 4 where the machine readable instructions that cause the haptic control circuit to generate an output signal that includes data indicative of at least one haptic output parameter corresponding to the received at least one displacement parameter may further cause the haptic control circuit to generate an output signal that includes data indicative of the haptic output pattern corresponding to the received displacement direction of the displaceable member.

Example 6 may include elements of example 4 where the machine readable instructions that cause the haptic control circuit to generate an output signal that includes data indicative of at least one haptic output parameter corresponding to the received at least one displacement parameter may further cause the haptic control circuit to generate an output signal that includes data indicative of the haptic output rhythm corresponding to the received displacement speed of the displaceable member.

Example 7 may include elements of example 4 where the machine readable instructions that cause the haptic control circuit to generate an output signal that includes data indicative of at least one haptic output parameter corresponding to the received at least one displacement parameter may further cause the haptic control circuit to generate an output signal that includes data indicative of the haptic output intensity corresponding to the received rate of change of the displacement speed of the displaceable member.

Example 8 may include elements of example 1 where the housing comprises a watch case and the displaceable member may include a rotatable bezel disposed about a watch crystal.

Example 9 may include elements of example 1 where the storage device may further include a data structure that includes data indicative of a plurality of haptic output parameters, each of the haptic output parameters corresponding to a respective ones of a plurality of displacement parameters; and where the machine readable instructions that cause the haptic control circuit to generate an output signal that includes data indicative of at least one haptic output parameter corresponding to the received at least one displacement parameter may further cause the haptic control circuit to retrieve from the data structure data indicative of the at least one haptic output parameter corresponding to the received at least one displacement parameter.

According to example 10, there is provided a wearable electronic device haptic feedback controller. The controller may include an input interface circuit to receive a signal that includes data indicative of at least one displacement parameter corresponding to a user input received via the displaceable member; an output interface circuit to provide an output signal that includes data indicative of at least one haptic output parameter; a configurable circuit communicably coupled to the input interface circuit and to the output interface circuit; and a storage device communicably coupled to the configurable circuit, the storage device including machine-readable instructions that, when executed by the configurable circuit transform at least a portion of the configurable circuit to a haptic control circuit, the haptic control circuit to: receive, via the input interface circuit, the signal that includes data indicative of at least one displacement parameter corresponding to a user input received via the displaceable member; and provide, via the output interface circuit, the output signal that includes data indicative of at least one haptic output parameter, wherein the at least one haptic output parameter corresponds to the received at least one displacement parameter.

Example 11 may include elements of example 10 where the data indicative of the at least one displacement parameter may include data indicative of at least one of: a displacement direction of the displaceable member; a displacement speed of the displaceable member; and a rate of change of the displacement speed of the displaceable member.

Example 12 may include elements of example 11 where the data indicative of the at least one haptic output parameter may include data indicative of at least one of: a haptic output pattern; a haptic output rhythm; and a haptic output intensity.

Example 13 may include elements of example 12 where the machine readable instructions that cause the haptic control circuit to generate an output signal that includes data indicative of at least one haptic output parameter corresponding to the received at least one displacement parameter may further cause the haptic control circuit to generate an output signal that includes data indicative of the haptic output pattern corresponding to the received displacement direction of the displaceable member.

Example 14 may include elements of example 12 where the machine readable instructions that cause the haptic control circuit to generate an output signal that includes data indicative of at least one haptic output parameter corresponding to the received at least one displacement parameter may further cause the haptic control circuit to generate an output signal that includes data indicative of the haptic output rhythm corresponding to the received displacement speed of the displaceable member.

Example 15 may include elements of example 12 where the machine readable instructions that cause the haptic control circuit to generate an output signal that includes data indicative of at least one haptic output parameter corresponding to the received at least one displacement parameter may further cause the haptic control circuit to generate an output signal that includes data indicative of the haptic output intensity corresponding to the received rate of change of the displacement speed of the displaceable member.

Example 16 may include elements of example 10 where the storage device may further include a data structure that includes data indicative of a plurality of haptic output parameters, each of the haptic output parameters corresponding to a respective ones of a plurality of displacement parameters; and where the machine readable instructions that cause the haptic control circuit to generate an output signal that includes data indicative of at least one haptic output parameter corresponding to the received at least one displacement parameter may further cause the haptic control circuit to retrieve from the data structure data indicative of the at least one haptic output parameter corresponding to the received at least one displacement parameter.

According to example 17, there is provided a method of providing haptic output on a wearable electronic device. The method may include receiving, at an input interface circuit, a signal that includes data indicative of at least one displacement parameter corresponding to a user input received via a displaceable member operably coupled to the wearable electronic device; determining, by a haptic control circuit, a haptic output parameter corresponding to the received signal that includes data indicative of at least one displacement parameter; generating, by the haptic control circuit, an output signal that includes data indicative of at least one haptic output parameter; and causing a displacement of a haptic output device disposed at least partially on an exterior surface of the wearable electronic device.

Example 18 may include elements of example 17 where receiving a signal that includes data indicative of at least one displacement parameter may include receiving a signal that includes data indicative of at least one of: a displacement direction of the displaceable member; a displacement speed of the displaceable member; and a rate of change of the displacement speed of the displaceable member.

Example 19 may include elements of example 18 where generating an output signal that includes data indicative of at least one haptic output parameter may include generating an output signal that includes data indicative of at least one of: a haptic output pattern; a haptic output rhythm; and a haptic output intensity.

Example 20 may include elements of example 18 where determining a haptic output parameter corresponding to the received signal that includes data indicative of at least one displacement parameter may include determining, by a haptic control circuit, a haptic output pattern corresponding to the received signal that includes data indicative of at least one displacement parameter.

Example 21 may include elements of example 18 where determining a haptic output parameter corresponding to the received signal that includes data indicative of at least one displacement parameter may include determining, by a haptic control circuit, a haptic output displacement corresponding to the received signal that includes data indicative of at least one displacement parameter.

Example 22 may include elements of example 18 where determining a haptic output parameter corresponding to the received signal that includes data indicative of at least one displacement parameter may include determining, by a haptic control circuit, a haptic output frequency corresponding to the received signal that includes data indicative of at least one displacement parameter.

Example 23 may include elements of example 18 where determining a haptic output parameter corresponding to the received signal that includes data indicative of at least one displacement parameter may include retrieving, from a data storage device, data indicative of the at least one haptic output parameter corresponding to the received at least one displacement parameter.

According to example 24, there is provided a system for providing haptic output on a wearable electronic device. The system may include a means for receiving a signal that includes data indicative of at least one displacement parameter corresponding to a user input received via a displaceable member operably coupled to the wearable electronic device; a means for determining a haptic output parameter corresponding to the received signal that includes data indicative of at least one displacement parameter; a means for generating an output signal that includes data indicative of at least one haptic output parameter; and a means for causing a displacement of a haptic output device disposed at least partially on an exterior surface of the wearable electronic device.

Example 25 may include elements of example 24 where the means for receiving a signal that includes data indicative of at least one displacement parameter may include a means for receiving a signal that includes data indicative of at least one of: a displacement direction of the displaceable member; a displacement speed of the displaceable member; and a rate of change of the displacement speed of the displaceable member.

Example 26 may include elements of example 25 where the means for generating an output signal that includes data indicative of at least one haptic output parameter may include a means for generating an output signal that includes data indicative of at least one of: a haptic output pattern; a haptic output rhythm; and a haptic output intensity.

Example 27 may include elements of example 25 where the means for determining a haptic output parameter corresponding to the received signal that includes data indicative of at least one displacement parameter may include a means for determining a haptic output pattern corresponding to the received signal that includes data indicative of at least one displacement parameter.

Example 28 may include elements of example 25 where the means for determining a haptic output parameter corresponding to the received signal that includes data indicative of at least one displacement parameter may include a means for determining a haptic output displacement corresponding to the received signal that includes data indicative of at least one displacement parameter.

Example 29 may include elements of example 25 where the means for determining a haptic output parameter corresponding to the received signal that includes data indicative of at least one displacement parameter may include a means for determining a haptic output frequency corresponding to the received signal that includes data indicative of at least one displacement parameter.

Example 30 may include elements of example 25 where the means for determining a haptic output parameter corresponding to the received signal that includes data indicative of at least one displacement parameter may include a means for retrieving data indicative of the at least one haptic output parameter corresponding to the received at least one displacement parameter.

According to example 31, there is provided a method of providing haptic output on a wearable electronic device. The method may include operably coupling a displaceable member to an external surface of a wearable electronic device; disposing a haptic array on at least a portion of the exterior surface of the wearable electronic device; communicably coupling the displaceable member to a haptic control circuit; communicably coupling the haptic array to the haptic control circuit; and communicably coupling a storage device that includes a library of haptic array outputs, each logically associated with a respective one of a plurality of inputs received via the displaceable member.

Example 32 may include elements of example 31 where operably coupling a displaceable member to an external surface of a wearable electronic device may include operably coupling a displaceable member that includes a watch bezel to a wearable electronic device that includes a watch case.

Example 33 may include elements of example 32 where disposing a haptic array on at least a portion of the exterior surface of the wearable electronic device may include disposing the haptic array on an external portion of the watch case that falls in contact with the device user.

According to example 34, there is provided a system for providing haptic output on a wearable electronic device. The system may include a means for operably coupling a displaceable member to an external surface of a wearable electronic device; a means for disposing a haptic array on at least a portion of the exterior surface of the wearable electronic device; a means for communicably coupling the displaceable member to a haptic control circuit; a means for communicably coupling the haptic array to the haptic control circuit; and a means for communicably coupling a storage device that includes a library of haptic array outputs, each logically associated with a respective one of a plurality of inputs received via the displaceable member.

Example 35 may include elements of example 34 where the means for operably coupling a displaceable member to an external surface of a wearable electronic device may include a means for operably coupling a displaceable member that includes a watch bezel to a wearable electronic device that includes a watch case.

Example 36 may include elements of example 35 where the means for disposing a haptic array on at least a portion of the exterior surface of the wearable electronic device may include a means for disposing the haptic array on an external portion of the watch case that falls in contact with the device user.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed:

1. A haptic feedback system for wearable electronic devices, the system comprising:
a housing;
a haptic output sub-system forming at least a portion of an exterior surface of the housing, the haptic output sub-system providing a selectively configurable haptic output pattern;
a displaceable member operably coupled to the housing;
a configurable circuit operably coupled to the displaceable member and to the haptic output sub-system; and
a storage device communicably coupled to the configurable circuit, the storage device including machine-readable instructions that, when executed by the configurable circuit transform at least a portion of the configurable circuit to a haptic control circuit, the haptic control circuit to:
receive a signal that includes data indicative of at least one displacement parameter corresponding to a user input received via the displaceable member; and
generate an output signal that includes data indicative of at least one haptic output parameter corresponding to the received at least one displacement parameter.

2. The system of claim 1 wherein the data indicative of the at least one displacement parameter includes data indicative of at least one of: a displacement direction of the displaceable member; a displacement speed of the displaceable member; and a rate of change of the displacement speed of the displaceable member.

3. The system of claim 2 wherein the data indicative of the at least one haptic output parameter includes data indicative of at least one of: a haptic output pattern; a haptic output rhythm; and a haptic output intensity.

4. The system of claim 3 wherein the haptic output subsystem comprises a plurality of linear resonant actuators, a plurality of eccentric rotating mass motors, a plurality of piezoelectric actuators, or a plurality of microfluidic actuators.

5. The system of claim 4 wherein the machine readable instructions that cause the haptic control circuit to generate an output signal that includes data indicative of at least one haptic output parameter corresponding to the received at least one displacement parameter further cause the haptic control circuit to:
generate an output signal that includes data indicative of the haptic output pattern corresponding to the received displacement direction of the displaceable member.

6. The system of claim 4 wherein the machine readable instructions that cause the haptic control circuit to generate an output signal that includes data indicative of at least one haptic output parameter corresponding to the received at least one displacement parameter further cause the haptic control circuit to:
generate an output signal that includes data indicative of the haptic output rhythm corresponding to the received displacement speed of the displaceable member.

7. The system of claim 4 wherein the machine readable instructions that cause the haptic control circuit to generate an output signal that includes data indicative of at least one haptic output parameter corresponding to the received at least one displacement parameter further cause the haptic control circuit to:
generate an output signal that includes data indicative of the haptic output intensity corresponding to the received rate of change of the displacement speed of the displaceable member.

8. The system of claim 1 wherein the housing comprises a watch case and the displaceable member comprises a rotatable bezel disposed about a watch crystal.

9. The system of claim 8 wherein the displaceable member further comprises a vertically displaceable rotatable bezel.

10. The system of claim 1:
wherein the storage device further includes a data structure that includes data indicative of a plurality of haptic output parameters, each of the haptic output parameters corresponding to a respective ones of a plurality of displacement parameters; and
wherein the machine readable instructions that cause the haptic control circuit to generate an output signal that includes data indicative of at least one haptic output parameter corresponding to the received at least one displacement parameter further cause the haptic control circuit to:
retrieve from the data structure data indicative of the at least one haptic output parameter corresponding to the received at least one displacement parameter.

11. A method of providing haptic output on a wearable electronic device, comprising:
receiving, at an input interface circuit, a signal that includes data indicative of at least one displacement parameter corresponding to a user input received via a displaceable member operably coupled to the wearable electronic device;
determining, by a haptic control circuit, a haptic output parameter corresponding to the received signal that includes data indicative of at least one displacement parameter;
generating, by the haptic control circuit, an output signal that includes data indicative of at least one haptic output parameter; and
causing a displacement of a haptic output device disposed at least partially on an exterior surface of the wearable electronic device.

12. The method of claim 11 wherein receiving a signal that includes data indicative of at least one displacement parameter comprises:
receiving a signal that includes data indicative of at least one of: a displacement direction of the displaceable member; a displacement speed of the displaceable member; and a rate of change of the displacement speed of the displaceable member.

13. The method of claim 12 wherein generating an output signal that includes data indicative of at least one haptic output parameter comprises:
generating an output signal that includes data indicative of at least one of: a haptic output pattern; a haptic output rhythm; and a haptic output intensity.

14. The method of claim 12 wherein determining a haptic output parameter corresponding to the received signal that includes data indicative of at least one displacement parameter comprises:
determining, by a haptic control circuit, a haptic output pattern corresponding to the received signal that includes data indicative of at least one displacement parameter.

15. The method of claim 12 wherein determining a haptic output parameter corresponding to the received signal that includes data indicative of at least one displacement parameter comprises:
determining, by a haptic control circuit, a haptic output displacement corresponding to the received signal that includes data indicative of at least one displacement parameter.

16. The method of claim 12 wherein determining a haptic output parameter corresponding to the received signal that includes data indicative of at least one displacement parameter comprises:
determining, by a haptic control circuit, a haptic output frequency corresponding to the received signal that includes data indicative of at least one displacement parameter.

17. The method of claim 12 wherein determining a haptic output parameter corresponding to the received signal that includes data indicative of at least one displacement parameter comprises:
retrieving, from a data storage device, data indicative of the at least one haptic output parameter corresponding to the received at least one displacement parameter.

18. A system for providing haptic output on a wearable electronic device, comprising:
a means for receiving a signal that includes data indicative of at least one displacement parameter corresponding to a user input received via a displaceable member operably coupled to the wearable electronic device;
a means for determining a haptic output parameter corresponding to the received signal that includes data indicative of at least one displacement parameter;
a means for generating an output signal that includes data indicative of at least one haptic output parameter; and
a means for causing a displacement of a haptic output device disposed at least partially on an exterior surface of the wearable electronic device.

19. The system of claim 18 wherein the means for receiving a signal that includes data indicative of at least one displacement parameter comprises:
a means for receiving a signal that includes data indicative of at least one of: a displacement direction of the displaceable member; a displacement speed of the displaceable member; and a rate of change of the displacement speed of the displaceable member.

20. The system of claim 19 wherein the means for generating an output signal that includes data indicative of at least one haptic output parameter comprises:
a means for generating an output signal that includes data indicative of at least one of: a haptic output pattern; a haptic output rhythm; and a haptic output intensity.

21. The system of claim 19 wherein the means for determining a haptic output parameter corresponding to the received signal that includes data indicative of at least one displacement parameter comprises:
a means for determining a haptic output pattern corresponding to the received signal that includes data indicative of at least one displacement parameter.

22. The system of claim 19 wherein the means for determining a haptic output parameter corresponding to the received signal that includes data indicative of at least one displacement parameter comprises:
a means for determining a haptic output displacement corresponding to the received signal that includes data indicative of at least one displacement parameter.

23. The system of claim 19 wherein the means for determining a haptic output parameter corresponding to the received signal that includes data indicative of at least one displacement parameter comprises:
a means for determining a haptic output frequency corresponding to the received signal that includes data indicative of at least one displacement parameter.

24. The system of claim 19 wherein the means for determining a haptic output parameter corresponding to the received signal that includes data indicative of at least one displacement parameter comprises:
a means for retrieving data indicative of the at least one haptic output parameter corresponding to the received at least one displacement parameter.

25. A method of providing haptic output on a wearable electronic device, comprising:
operably coupling a displaceable member to an external surface of a wearable electronic device;
disposing a haptic array on at least a portion of the exterior surface of the wearable electronic device;
communicably coupling the displaceable member to a haptic control circuit;
communicably coupling the haptic array to the haptic control circuit; and
communicably coupling a storage device that includes a library of haptic array outputs, each logically associated with a respective one of a plurality of inputs received via the displaceable member.

26. The method of claim 25 wherein operably coupling a displaceable member to an external surface of a wearable electronic device comprises:
operably coupling a displaceable member that includes a watch bezel to a wearable electronic device that includes a watch case.

27. The method of claim 26 wherein disposing a haptic array on at least a portion of the exterior surface of the wearable electronic device comprises:
disposing the haptic array on an external portion of the watch case that falls in contact with the device user.
